(19) United States
(12) Patent Application Publication
(10) Pub. No.: US 2026/0288656 A1
(43) Pub. Date: Sep. 24, 2026

(54) APPARATUS AND METHOD FOR PROTECTING MEMORY IN EMBEDDED SYSTEM

(71) Applicant: University-Industry Cooperation Group of Kyung Hee University, Gyeonggi-do (KR)

(72) Inventors: JINSUNG CHO, Gyeonggi-do (KR); HEE SEUNG SON, Gyeonggi-do (KR)

(21) Appl. No.: 19/554,889

(22) Filed: Mar. 3, 2026

(30) Foreign Application Priority Data
Mar. 19, 2025 (KR) 10-2025-0035605

(51) Int. Cl. G06F 12/14

(52) U.S. Cl. CPC G06F 12/1483; G06F 12/1441

(57) ABSTRACT

A memory protection apparatus in an embedded system includes one or more processors and a memory storing one or more programs executable by the one or more processors, and includes an access grant list generation module configured to generate an access grant list for components constituting a task, a task execution management module configured to, when the task is executed, generate a management table based on a memory region assigned to the task and manage an executing task based on the management table, and an interrupt management module configured to, when an interrupt is generated by the task execution management module, process the interrupt based on the access grant list.

### CROSS-REFERENCE TO RELATED APPLICATION AND CLAIM OF PRIORITY

This application claims the benefit under 35 U.S.C. §119 of Korean Patent Application No. 10-2025-0035605 filed on Mar. 19, 2025, in the Korean Intellectual Property Office, the entire disclosure of which is incorporated herein by reference for all purposes.

### BACKGROUND

### 1. Field

The present disclosure relates to memory protection techniques in embedded systems.

### 2. Description of Related Art

In general, an embedded system operates in a resource-constrained environment and is executed in a real-time operating system (RTOS) environment. In such a system, advanced memory management techniques such as virtual memory management are not required, and thus a complex memory management device such as a memory management unit (MMU) is often not used.

A memory management unit provides various memory protection functions along with virtual memory management. However, implementing such functions requires relatively expensive hardware resources. Because miniaturization and cost reduction are important factors for embedded devices, such complex hardware is not used in many cases, and instead a memory protection unit (MPU) is employed. The MPU has a simpler structure than an MMU, does not support virtual memory, and provides only physical memory protection to maintain memory security of the system.

However, the MPU has functional limitations compared to the MMU. In particular, since the number of memory regions that can be registered is limited, it is difficult to satisfy dynamic memory requirements. As the system becomes more complex and multiple tasks share or need to protect memory, the MPU has limitations in processing such situations efficiently. In addition, the size of a memory region that can be protected by the MPU should be configured based on a fixed unit, and typically must be set as a multiple of, for example, 32 bytes. Such restrictions make it difficult to flexibly configure memory protection regions, resulting in reduced flexibility in situations where memory blocks of various sizes are dynamically managed or protected.

Accordingly, in MPU-based hardware it is difficult to apply advanced MMU-based memory protection techniques as-is, and there is an inevitable limitation in handling dynamic memory protection requirements. This limitation becomes problematic particularly in a real-time system (RTOS environment) in which multiple tasks are executed concurrently. That is, if memory access conflicts occur between tasks, or if memory protection regions are not properly configured, system stability may be degraded and security issues may be more likely to occur.

Examples of related art include Korean Patent Registration No. 10-0900439 (issued May 26, 2022).

### SUMMARY

Embodiments of the present disclosure provide a memory protection apparatus for an embedded system.

According to an example embodiment, a memory protection apparatus includes one or more processors and a memory storing one or more programs executable by the one or more processors, and includes: an access grant list generation module configured to generate an access grant list for components constituting a task; a task execution management module configured to, when the task is executed, generate a management table based on a memory region assigned to the task and manage the task based on the management table; and an interrupt management module configured to, when an interrupt is generated by the task execution management module, process the interrupt based on the access grant list.

The memory protection apparatus may further include a memory region configuration module configured to partition the memory into regions of a predetermined size to set a plurality of memory regions and, when the task is executed, assign the components constituting the task to the set plurality of memory regions, respectively.

The access grant list generation module may, when the task is compiled, extract each function and each global variable constituting the compiled task and generate a static access grant list based on the extracted functions and global variables, and when the task is executed, generate a dynamic access grant list based on a stack and a heap assigned to the executing task.

The task execution management module may, when the task calls a component during execution, check whether the called component is included in the management table, and when the called component is not included in the management table, generate the interrupt and suspend the task.

The interrupt management module may check whether the called component is included in the access grant list, determine that the called component is unauthorized to access memory when the called component is not included in the access grant list, and cause the task execution management module to generate a memory error.

The interrupt management module may check whether the called component is included in the access grant list, and determine that the called component is authorized to access memory when the called component is included in the access grant list.

When the called component is determined to be authorized to access memory by the interrupt management module, the task execution management module may update the management table such that the called component is included in the management table.

According to another example embodiment, a method performed by a computing device including one or more processors and a memory storing one or more programs executable by the one or more processors includes: generating an access grant list for components constituting a task; when the task is executed, generating a management table based on a memory region assigned to the task; and managing the task based on the management table, wherein managing the task includes processing an interrupt based on the access grant list when the interrupt is generated.

According to still another example embodiment, there is provided a computer program stored in a non-transitory computer-readable storage medium, the computer program including one or more instructions that, when executed by a computing device having one or more processors, cause the computing device to perform: generating an access grant list for components constituting a task; when the task is executed, generating a management table based on a memory region assigned to the task; and managing the task based on the management table, wherein managing the task includes processing an interrupt based on the access grant list when the interrupt is generated.

According to embodiments of the present disclosure, memory access between tasks can be effectively controlled and each task can be protected from accessing outside a memory region assigned thereto, thereby preventing memory conflict issues that may occur in an existing embedded system and improving stability and security of the system.

Further, according to embodiments of the present disclosure, memory protection regions can be efficiently managed and dynamic changes in memory requirements can be addressed, thereby providing a stable memory protection environment even in a complex real-time system.

### BRIEF DESCRIPTION OF THE DRAWINGS

FIG. 1 is a diagram illustrating a configuration of a memory protection apparatus in an embedded system according to one embodiment of the present disclosure.

FIG. 2 is a diagram illustrating a memory structure configured by a memory protection apparatus in an embedded system according to one embodiment of the present disclosure.

FIG. 3 is a diagram for describing an operation of a memory protection apparatus in an embedded system according to one embodiment of the present disclosure.

FIG. 4 is a flowchart illustrating a memory protection method in an embedded system according to one embodiment of the present disclosure.

FIG. 5 is a block diagram illustrating a computing environment including a computing device suitable for use in some embodiments.

### DETAILED DESCRIPTION

Hereinafter, specific embodiments of the present disclosure will be described with reference to the accompanying drawings. The following detailed description is provided to assist in a comprehensive understanding of the methods, apparatuses, and/or systems described herein. However, the description is merely illustrative, and the present disclosure is not limited thereto.

In describing embodiments of the present disclosure, detailed descriptions of well-known technologies related to the present disclosure will be omitted when it is determined that such descriptions may unnecessarily obscure the gist of the present disclosure. The terms used hereinafter are terms defined in consideration of functions in the present disclosure, and may vary depending on the intention or custom of a user or operator. Accordingly, such terms should be construed based on the contents throughout the specification. The terms used in the detailed description are only for describing embodiments and should not be construed as limiting. Unless clearly indicated otherwise, singular expressions include plural meanings.

In the following description, the terms having meanings similar to 'transmission', 'communication', 'sending', 'receiving', or the like of a signal or information include not only a case in which the signal or information is directly transferred from one component to another component but also a case in which the signal or information is transferred via another component. In particular, 'transmitting' or 'sending' a signal or information to a component indicates a final destination of the signal or information and does not mean an immediate destination. The same applies to 'receiving' a signal or information. Further, in this specification, two or more pieces of data or information being 'associated' means that when one piece of data (or information) is obtained, at least a part of the other piece of data (or information) can be obtained based thereon.

Also, terms such as first and second may be used to describe various components, but the components should not be limited by such terms. Such terms are used only for distinguishing one component from another component. For example, without departing from the scope of the present disclosure, a first component may be referred to as a second component, and similarly a second component may be referred to as a first component.

Meanwhile, embodiments of the present disclosure may include a program for performing the methods described herein on a computer, and a computer-readable recording medium including the program. The computer-readable recording medium may include program instructions, local data files, local data structures, and the like, alone or in combination. The medium may be specially designed and configured for the present disclosure, or may be generally available in the computer software field. Examples of computer-readable recording media include magnetic media such as hard disks, floppy disks, and magnetic tapes; optical recording media such as CD-ROMs and DVDs; and hardware devices specially configured to store and execute program instructions, such as ROM, RAM, flash memory, and the like. Examples of programs include not only machine code such as that generated by a compiler but also high-level language code executable by a computer using an interpreter or the like.

In addition, in the present embodiments, the term 'module' may refer to a software component or a hardware component such as an FPGA (field programmable gate array) or an ASIC, and a 'module' performs certain roles. However, a 'module' is not limited to software or hardware. A module may be configured to be in an addressable storage medium or configured to be executed by one or more processors. Thus, as an example, a module may include software components, object-oriented software components, class components, and task components, and may include processes, functions, attributes, procedures, subroutines, segments of program code, drivers, firmware, microcode, circuits, data, databases, data structures, tables, arrays, and variables.

Functions provided within components and modules may be combined into a smaller number of components or modules, or may be separated into additional components or modules. Further, components and modules may be implemented to execute on one or more CPUs in a device or a secure multimedia card.

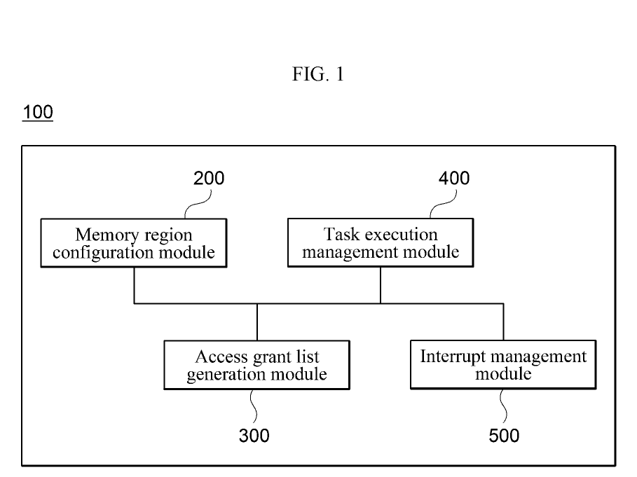

FIG. 1 is a diagram illustrating a configuration of a memory protection apparatus in an embedded system according to one embodiment.

Referring to FIG. 1, a memory protection apparatus 100 in an embedded system according to one embodiment may include a memory region configuration module 200, an access grant list generation module 300, a task execution management module 400, and an interrupt management module 500. The memory protection apparatus 100 according to an example embodiment is for protecting memory in an embedded system in a Real-Time Operating System (RTOS) environment. Except for the functions described herein, the memory protection apparatus 100 may perform the same functions as a conventional memory protection unit (MPU).

The memory region configuration module 200 may partition memory into regions of a predetermined size to set a plurality of memory regions. Here, each region having the predetermined size may be a multiple of a minimum unit size controllable by the memory protection apparatus (i.e., a manageable size preset in the memory protection apparatus).

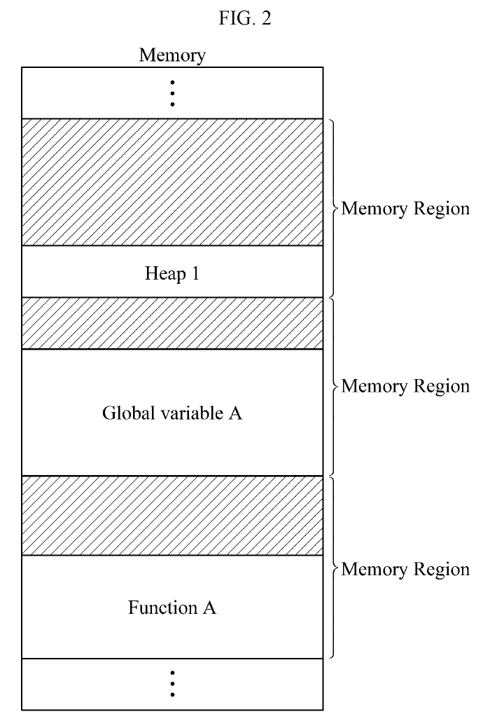

FIG. 2 is a diagram illustrating a memory structure configured by a memory protection apparatus in an embedded system according to one embodiment.

In general, within memory, components of a task (process) (such as functions, variables, a stack, and a heap) are assigned contiguously. However, an MPU configures the size of a memory region to be protected based on a predetermined unit and protects memory based on the configured region, and thus cannot finely protect contiguously allocated components. For example, in an ARMv8 architecture, up to eight memory regions may be designated, and a size of a memory region that can be protected must be set as a multiple of 32 bytes.

As illustrated in FIG. 2, the memory protection apparatus 100 according to one embodiment partitions memory into regions of a predetermined size to set a plurality of memory regions and assigns functions, variables, a stack, a heap, and the like constituting a task to the set memory regions, respectively, thereby enabling finer-grained memory protection (independently applying memory protection settings per component) in a constrained environment. In this case, when a size of a component is greater than a size of the set memory region, the component may be assigned to contiguous memory regions.

The access grant list generation module 300 may generate an access grant list for components constituting a task. Specifically, the access grant list generation module 300 may extract each function and each global variable constituting a compiled task and generate a static access grant list based on identification information of the extracted functions and global variables. In addition, the access grant list generation module 300 may generate a dynamic access grant list based on identification information of a stack and a heap assigned to an executing task. In this case, the access grant list generation module 300 may generate an access grant list for each task.

For example, at a time when a task is compiled, the access grant list generation module 300 may extract each function and each global variable constituting the task and generate a static access grant list based on identification information of the extracted functions and global variables. That is, because functions and global variables constituting the task have memory addresses (identification information) that do not change at runtime, the task may be analyzed in a compilation process to define access grants to statically allocated memory regions and generate the list. In addition, at a time when the task is executing, the access grant list generation module 300 may generate a dynamic access grant list based on identification information of a stack and a heap that are assigned to and released from the task. That is, because the stack and heap are allocated and released during execution and thus have memory addresses that change at runtime, access grants to memory regions that are allocated (or released) during execution may be dynamically defined and the list may be generated.

The task execution management module 400 may generate a management table based on a memory region assigned to an executing task and manage a component called in the executing task based on the management table.

In one embodiment, the task execution management module 400 may check whether a component called by an executing task is included in the management table, and when the called component is included in the management table, call and execute the corresponding component.

When a component called by the executing task is not included in the management table, the task execution management module 400 may generate an interrupt. Thereafter, the task execution management module 400 may update the management table based on a processing result of the interrupt management module 500 and resume execution of the task suspended by the interrupt.

For example, based on the processing result of the interrupt management module 500, the task execution management module 400 may update the management table such that the called component is included in the management table. Because the management table has a limited size, when the management table is full, the task execution management module 400 may delete a component included in the existing management table and update the management table. Here, the deleted component may be the least recently used component, but is not limited thereto, and may be configured differently according to a user setting.

Further, based on the processing result of the interrupt management module 500, the task execution management module 400 may generate a memory error and display occurrence of the error to notify a user. However, embodiments are not limited thereto, and the memory error may be handled according to a memory error handling process set by the user.

Meanwhile, when context switching occurs, the task execution management module 400 may store a context and the management table of a currently executing task and load a context and a management table of a newly switched task for execution.

When an interrupt is generated by the task execution management module 400, the interrupt management module 500 may process the interrupt based on the access grant list.

In one embodiment, when an interrupt is generated by the task execution management module 400, the interrupt management module 500 may check whether a component called by the suspended task is included in the access grant list of the task suspended by the interrupt. When the called component is not included in the access grant list, the interrupt management module 500 may determine that the called component is unauthorized to access memory and cause the task execution management module 400 to generate a memory error. When the called component is included in the access grant list, the interrupt management module 500 may determine that the called component is authorized to access memory and cause the task execution management module 400 to update the management table.

Accordingly, the memory protection apparatus in an embedded system according to one embodiment may generate an access grant list for a task and dynamically update a management table based on the access grant list, thereby effectively protecting memory regions even in an environment in which the number of manageable entries is limited (i.e., the size of the management table is limited).

Further, in an embedded system according to one embodiment, the memory protection apparatus may prevent each task from accessing memory outside an authorized memory region defined by an access grant list, thereby preventing memory access conflicts that may occur in a conventional embedded system and improving system stability and security.

Further, the memory protection apparatus in an embedded system according to one embodiment of the present disclosure may configure a plurality of memory regions by partitioning memory into regions of a predetermined size, and may respectively assign components constituting a task to the configured memory regions, thereby independently applying a memory protection setting to each component and, in a constrained environment, more finely protecting memory.

In this specification, a module may mean a functional and structural combination of hardware for implementing the technical idea of the present disclosure and software for operating the hardware. For example, a 'module' may mean a logical unit of predetermined code and hardware resources for executing the code, and does not necessarily mean physically connected code or a single type of hardware.

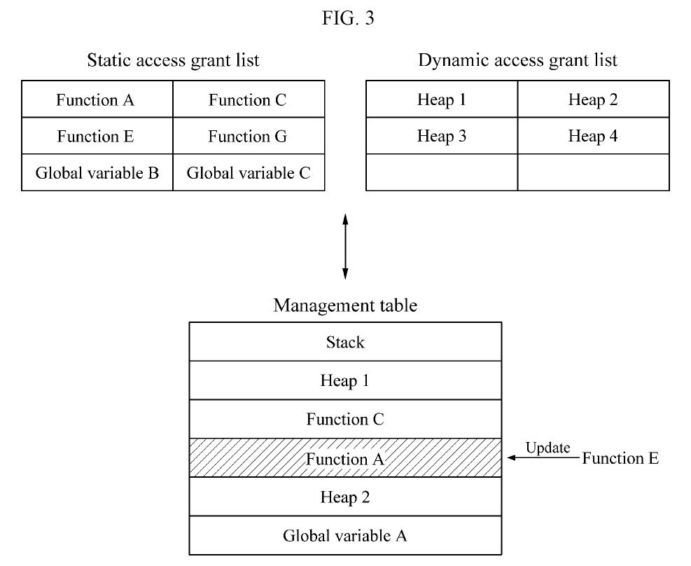

FIG. 3 is a diagram for describing an operation of a memory protection apparatus in an embedded system according to an example embodiment.

FIG. 3 illustrates a state in which an interrupt has been generated because a component (Function E) called by a currently executing task is not included in the management table. The memory protection apparatus 100 suspends the currently executing task, and may check whether the called component (Function E) is included based on a static access grant list and a dynamic access grant list of the suspended task. In FIG. 3, it may be confirmed that the called component (Function E) is included in the static access grant list. Accordingly, the memory protection apparatus 100 determines that the component is authorized to access memory and may update the management table. In this case, because the management table is full, the memory protection apparatus 100 may delete a component (Function A) that was least recently used among entries in the management table and update the management table to include the called component (Function E).

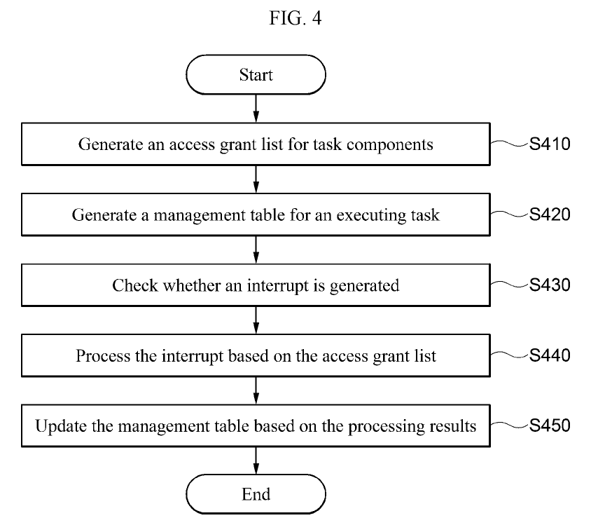

FIG. 4 is a flowchart illustrating a memory protection method in an embedded system according to an example embodiment. The method illustrated in FIG. 4 may be performed, for example, by the memory protection apparatus in the embedded system described above. Although the method is described as a plurality of steps in the flowchart, at least some of the steps may be performed in a different order, may be performed in combination with other steps, may be omitted, may be divided into detailed steps, or one or more steps not shown may be added.

In step 410, the memory protection apparatus 100 may generate an access grant list for task components. In this case, the memory protection apparatus 100 may be in a state in which the memory is partitioned into regions of a predetermined size to set a plurality of memory regions. Here, each region having the predetermined size may be a multiple of a minimum unit size controllable by the memory protection apparatus (i.e., a manageable size preset in the memory protection apparatus). Specifically, the memory protection apparatus 100 may extract each function and each global variable constituting a compiled task and generate a static access grant list based on identification information of the extracted functions and global variables. In addition, the memory protection apparatus 100 may generate a dynamic access grant list based on identification information of a stack and a heap allocated to an executing task. The memory protection apparatus 100 may generate an access grant list for each task.

In step 420, the memory protection apparatus 100 may generate a management table for an executing task.

In step 430, the memory protection apparatus 100 may check whether an interrupt is generated. Specifically, the memory protection apparatus 100 may check whether a component called by an executing task is included in the management table, and when the called component is included in the management table, call and execute the component. When the called component is not included in the management table, the memory protection apparatus 100 may generate an interrupt.

In step 440, the memory protection apparatus 100 may process the interrupt based on the access grant list. Specifically, the memory protection apparatus 100 may check whether a component called by the suspended task is included in the access grant list of the task suspended by the interrupt, and when the called component is included in the access grant list, determine that the called component is authorized to access memory.

In step 450, the memory protection apparatus 100 may update the management table based on the processing result. Specifically, when the called component is determined to be authorized to access memory, the memory protection apparatus 100 may update the management table such that the called component is included in the management table, and resume execution of the task suspended by the interrupt.

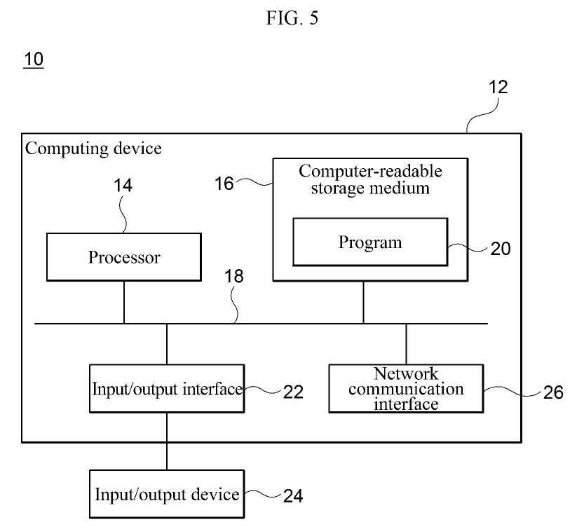

FIG. 5 is a block diagram illustrating a computing environment including a computing device suitable for use in example embodiments. In the illustrated embodiment, each component may have functions and capabilities different from those described below and may include additional components.

The illustrated computing environment 10 includes a computing device 12. In one embodiment, the computing device 12 may be the memory protection apparatus 100 in an embedded system.

The computing device 12 includes at least one processor 14, a computer-readable storage medium 16, and a communication bus 18. The processor 14 may cause the computing device 12 to operate according to the example embodiments described above. For example, the processor 14 may execute one or more programs stored in the computer-readable storage medium 16. The one or more programs may include one or more computer-executable instructions, which when executed by the processor 14 cause the computing device 12 to perform operations according to example embodiments.

The computer-readable storage medium 16 is configured to store computer-executable instructions or program code, program data, and/or other suitable forms of information. A program 20 stored in the computer-readable storage medium 16 includes a set of instructions executable by the processor 14. In one embodiment, the computer-readable storage medium 16 may be a memory (such as volatile memory including RAM, non-volatile memory, or a suitable combination thereof), one or more magnetic disk storage devices, optical disk storage devices, flash memory devices, other forms of storage media accessible by the computing device 12 and capable of storing desired information, or a suitable combination thereof.

The communication bus 18 interconnects various other components of the computing device 12, including the processor 14 and the computer-readable storage medium 16.

The computing device 12 may further include one or more input/output (I/O) interfaces 22 providing an interface for one or more I/O devices 24 and one or more network communication interfaces 26. The I/O interface(s) 22 and the network communication interface(s) 26 are connected to the communication bus 18. The I/O device(s) 24 may be connected to other components of the computing device 12 through the I/O interface(s) 22. Example I/O devices 24 include pointing devices (mouse, trackpad, etc.), a keyboard, a touch input device (touchpad, touchscreen, etc.), voice or sound input devices, various types of sensor devices and/or imaging devices, as input devices, and/or display devices, printers, speakers, and/or network cards, as output devices. Example I/O devices 24 may be included inside the computing device 12 as one component of the computing device 12, or may be separate devices distinct from the computing device 12 and connected thereto.

Although representative embodiments have been described in detail above, those of ordinary skill in the art will understand that various modifications may be made thereto without departing from the scope of the present disclosure. Therefore, the scope of the present disclosure should not be limited to the described embodiments, but should be defined by the appended claims and equivalents thereof.

What is claimed is:

1. A memory protection apparatus comprising:
one or more processors;
a memory storing one or more programs executable by the one or more processors;
an access grant list generation module configured to generate an access grant list for components constituting a task;
a task execution management module configured to, when the task is executed, generate a management table based on a memory region assigned to the task and manage the task based on the management table; and
an interrupt management module configured to, when an interrupt is generated by the task execution management module, process the interrupt based on the access grant list.

2. The memory protection apparatus of claim 1, further comprising a memory region configuration module configured to partition the memory into regions of a predetermined size to set a plurality of memory regions and, when the task is executed, to assign the components constituting the task to the set plurality of memory regions, respectively.

3. The memory protection apparatus of claim 1, wherein the access grant list generation module is configured to:
when the task is compiled, extract each function and each global variable constituting the compiled task and generate a static access grant list based on the extracted functions and global variables; and
when the task is executed, generate a dynamic access grant list based on a stack and a heap assigned to the executing task.

4. The memory protection apparatus of claim 1, wherein the task execution management module is configured to:
when the task calls a component during execution, check whether the called component is included in the management table; and
when the called component is not included in the management table, generate the interrupt and suspend the task.

5. The memory protection apparatus of claim 4, wherein the interrupt management module is configured to check whether the called component is included in the access grant list, determine that the called component is unauthorized to access memory when the called component is not included in the access grant list, and cause the task execution management module to generate a memory error.

6. The memory protection apparatus of claim 4, wherein the interrupt management module is configured check whether the called component is included in the access grant list, and determine that the called component is authorized to access memory when the called component is included in the access grant list.

7. The memory protection apparatus of claim 6, wherein, when the called component is determined to be authorized to access memory by the interrupt management module, the task execution management module is configured to update the management table such that the called component is included in the management table.

8. A memory protection method performed by a computing device comprising one or more processors and a memory storing one or more programs executable by the one or more processors, the method comprising:
generating an access grant list for components constituting a task;
when the task is executed, generating a management table based on a memory region assigned to the task; and
managing the task based on the management table,
wherein managing the task comprises processing an interrupt based on the access grant list when the interrupt is generated.

9. The method of claim 8, further comprising:
partitioning the memory into regions of a predetermined size to set a plurality of memory regions; and
when the task is executed, assigning the components constituting the task to the set plurality of memory regions, respectively.

10. The method of claim 8, wherein the generating of the access grant list comprises:
when the task is compiled, extracting each function and each global variable constituting the compiled task;
generating a static access grant list based on the extracted functions and global variables; and
when the task is executed, generating a dynamic access grant list based on a stack and a heap assigned to the executing task.

11. The method of claim 8, wherein the managing of the task comprises:
when the task calls a component during execution, checking whether the called component is included in the management table; and
when the called component is not included in the management table, generating the interrupt and suspending the task.

12. The method of claim 11, wherein the processing of the interrupt comprises:
comparing an access grant list of the suspended task with the called component;
when the called component is not included in the access grant list, determining that the called component is unauthorized to access memory; and
generating a memory error.

13. The method of claim 11, wherein the processing of the interrupt comprises:
comparing an access grant list of the suspended task with the called component; and
when the called component is included in the access grant list, determining that the called component is authorized to access memory.

14. The method of claim 13, wherein the managing of the task further comprises, when the called component is determined to be authorized to access memory, updating the management table such that the called component is included in the management table.

15. A computer program stored in a non-transitory computer-readable storage medium, the computer program comprising one or more instructions that, when executed by a computing device having one or more processors, cause the computing device to perform:
generating an access grant list for components constituting a task;
when the task is executed, generating a management table based on a memory region assigned to the task; and
managing the task based on the management table,
wherein managing the task comprises processing an interrupt based on the access grant list when the interrupt is generated.
